(19) United States
(12) Patent Application Publication
(10) Pub. No.: US 2025/0053289 A1
(43) Pub. Date: Feb. 13, 2025

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: KAZUKI KADO, Kanagawa (JP)

(21) Appl. No.: 18/796,043

(22) Filed: Aug. 6, 2024

(30) Foreign Application Priority Data
Aug. 8, 2023 (JP) 2023-129008

(51) Int. Cl. G06F 3/04847; G06F 3/0487

(52) U.S. Cl. CPC G06F 3/04847; G06F 3/0487

(57) ABSTRACT

An image processing apparatus includes a display control unit that displays a setting screen for receiving setting of a setting value for a predetermined process, and a receiving unit that receives a user operation on a predetermined region indicating closing of the setting screen on the setting screen, wherein the display control unit displays a notification screen regarding whether to set the setting value for the predetermined process in a case where a user operation on the predetermined region is received, executes first control to set the setting value for the predetermined process in a case where an operation of setting the setting value for the predetermined process is received in the notification screen, and executes second control to not set the setting value for the predetermined process in a case where an operation of not setting the setting value for the predetermined process is received in the notification screen.

### BACKGROUND

### Field of the Disclosure

The present disclosure relates to an image processing apparatus, a control method for an image processing apparatus, and a storage medium.

### Description of the Related Art

There is known a technique in which a setting related to a predetermined process is performed using a setting screen on which a plurality of setting content candidates is displayed. A user selects setting content for the predetermined process on the setting screen to execute setting.

Japanese Patent Application Laid-Open No. 2007-304809 discusses a technique in which a setting method related to a predetermined process is switched on a setting screen of an image processing apparatus, depending on the level of a user's proficiency in the operations of the apparatus. Specifically, when the image processing apparatus is operating in a beginner mode, a user presses a button for selecting a desired option and then presses a button for confirming the selection to finalize the setting. On the other hand, when the image processing apparatus is operating in an expert mode, a user presses a button for selecting a desired option to finalize the setting.

However, in the technique discussed in Japanese Patent Application Laid-Open No. 2007-304809, there is a possibility that the setting that the user has made may be discarded unintentionally by an operation of the user. Therefore, it is demanded to improve the user convenience in the operation of the setting screen.

### SUMMARY

According to embodiments of the present disclosure, an image processing apparatus includes a display control unit configured to display a setting screen for receiving setting of a setting value for a predetermined process, and a receiving unit configured to receive a user operation on a predetermined region indicating closing of the setting screen on the setting screen, wherein the display control unit displays a notification screen regarding whether to set the setting value received in the setting screen for the predetermined process in a case where a user operation on the predetermined region is received, executes first control of setting the setting value for the predetermined process in a case where an operation indicating that the setting value is to be set for the predetermined process is received in the notification screen, and executes second control of not setting the setting value for the predetermined process in a case where an operation indicating that the setting value is not to be set for the predetermined process is received in the notification screen.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration of an image processing apparatus according to an exemplary embodiment.

FIG. 2 is a diagram illustrating a software configuration of the image processing apparatus according to an exemplary embodiment.

FIG. 3 is a flowchart illustrating a process of displaying a setting screen.

FIG. 4A is a diagram illustrating a setting screen according to an exemplary embodiment.

FIG. 4B is a diagram illustrating a setting screen according to an exemplary embodiment.

FIG. 4C is a diagram illustrating a setting screen according to an exemplary embodiment.

FIG. 5 is a flowchart illustrating a process of setting a setting value for a predetermined item.

FIG. 6A is a diagram illustrating an example of a screen regarding whether to reflect a setting according to an exemplary embodiment.

FIG. 6B is a diagram illustrating an example of a screen regarding whether to reflect a setting according to an exemplary embodiment.

FIG. 6C is a diagram illustrating an example of a screen regarding whether to reflect a setting according to an exemplary embodiment.

FIG. 7 is a diagram illustrating a setting screen according to an exemplary embodiment.

### DESCRIPTION OF THE EMBODIMENTS

The present disclosure will be described in detail with reference to the drawings. Note that the following exemplary embodiment does not limit the present disclosure recited in the scope of claims, and not all combinations of features described in the exemplary embodiment are necessarily essential to the solving means of the present disclosure. In the accompanying drawings, the same or similar components are denoted by the same reference numerals, and redundant description thereof will be omitted.

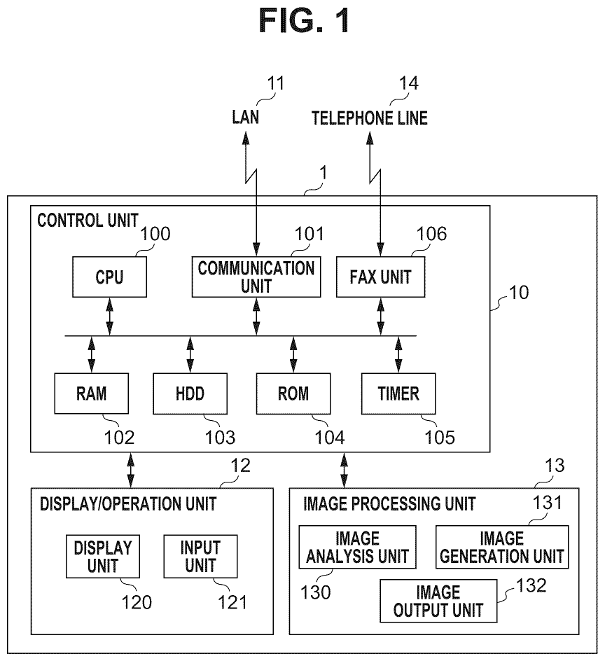

FIG. 1 is a block diagram illustrating an example of a hardware configuration of an image processing apparatus according to an exemplary embodiment of the present disclosure.

In an image processing apparatus 1 according to the present exemplary embodiment, a control unit 10 performs operation control of each unit of the image processing apparatus 1. The control unit 10 includes a central processing unit (CPU) 100, a communication unit 101, a random access memory (RAM) 102, a hard disk drive (HDD) 103, a read only memory (ROM) 104, a timer 105, and a facsimile (FAX) unit 106. The image processing apparatus 1 may be a printing apparatus that forms information, such as texts and graphics, based on a predetermined recording method. The predetermined recording method is an inkjet recording method or an electrophotographic method.

The image processing apparatus 1 may function as a copy machine or may be a multi-function peripheral (MFP) having other functions. Further, the image processing apparatus 1 may be a personal computer (PC), a tablet terminal, a smartphone, various electronic devices, or a home appliance.

The CPU 100 controls the entire control unit 10.

A local area network (LAN) 11 indicates a network for data transmission and reception with an external apparatus, and the image processing apparatus 1 is connected to the Internet via the LAN 11. The communication unit 101 transmits and receives data to and from the external apparatus via the LAN 11.

The RAM 102 provides a system work memory for the CPU 100 to operate.

The HDD 103 may be other storage devices, such as a magnetic disk, an optical medium, a flash memory, or a combination of these. The HDD 103 can store job data, setting data, and the like. The HDD 103 may not be included in the image processing apparatus 1. For example, an external server, a personal computer, or the like may be used as a storage device via the communication unit 101.

The ROM 104 is a boot ROM that stores a boot program for the system. The CPU 100 loads a program installed in the HDD 103 into the RAM 102 by using the boot ROM of the ROM 104 and performs various control operations based on the program.

The timer 105 measures time in accordance with an instruction from the CPU 100, and makes notification to the CPU 100 by interrupt processing or the like when the instructed time has elapsed.

The FAX unit 106 transmits and receives fax data via a telephone line 14.

A display/operation unit 12 is controlled by the control unit 10 and includes a display unit 120 and an input unit 121.

The display unit 120 is a screen (display) for displaying information about the image processing apparatus 1 (characters, pictures, quick response code (QR Codes®), etc.) for a user. For example, the display unit 120 is a liquid crystal display.

The input unit 121 receives an input from a user through an interface, such as a touch panel, a mouse, a camera, a voice input, or a keyboard.

An image processing unit 13 is controlled by the control unit 10, and includes an image analysis unit 130, an image generation unit 131, and an image output unit 132.

The image analysis unit 130 analyzes the structure of a document image and extracts necessary information from a result of the analysis.

The image generation unit 131 reads (for example, scans) a document, digitizes an image of the document to generate image data, and stores the image data in the HDD 103. The image generation unit 131 can also generate document image data in another format using information analyzed by the image analysis unit 130.

The image output unit 132 outputs the image data stored in the HDD 103.

Examples of the output method include printing the image data of the document on a sheet, transmitting the image data to an external device, a server, a facsimile apparatus, or the like connected to the network via the communication unit 101, and storing the image data in a storage medium connected to the image processing apparatus 1.

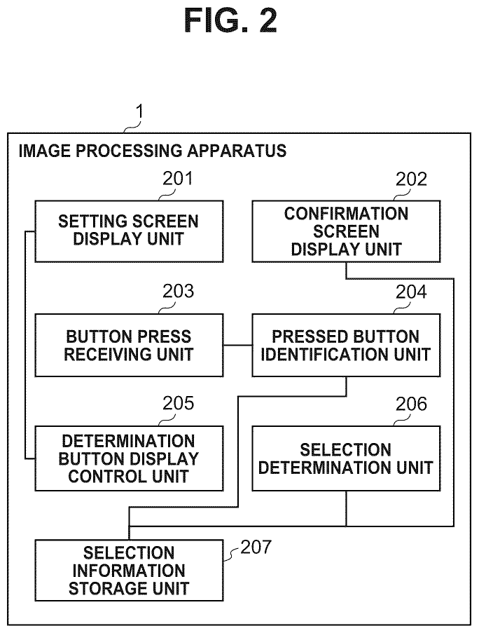

FIG. 2 is a diagram illustrating an example of a configuration of software that is a function of the image processing apparatus 1.

The image processing apparatus 1 includes, as its functions, a setting screen display unit 201, a confirmation screen display unit 202, a button press receiving unit 203, a pressed button identification unit 204, a determination button display control unit 205, a selection determination unit 206, and a selection information storage unit 207. These functional units are implemented when the CPU 100 loads a program installed in the HDD 103 into the RAM 102 by using the boot ROM of ROM 104 and executes the program.

The setting screen display unit 201 performs processing for displaying a setting screen and processing for closing a setting screen. The setting screen displayed and controlled by the setting screen display unit 201 corresponds to a setting screen that displays a plurality of pieces of information (hereinafter, referred to as “setting values”) indicating setting content for a setting item, receives a selection operation for any of the displayed setting values, and sets the setting value for the setting item to a predetermined item.

When the user changes the selection of the setting value on the setting screen and then presses a button for closing the setting screen without confirming the setting, the confirmation screen display unit 202 displays a confirmation screen (notification screen) regarding whether to reflect the change of the setting value (i.e., whether to set the selected setting value).

The button press receiving unit 203 detects an operation on a predetermined region in the display unit 120. For example, the button press receiving unit 203 detects that a predetermined button is pressed by the user.

The pressed button identification unit 204 identifies a button pressed by the user and identifies a setting screen associated with the button.

The determination button display control unit 205 determines whether to display an OK button as a button (software key) for determining the selection on the setting screen.

The selection determination unit 206 determines the selection by an operation performed by the user on the setting screen.

The selection information storage unit 207 stores the option currently selected on the setting screen on which the OK button is displayed. When the screen is changed to the setting screen, the selection information storage unit 207 stores the initial value.

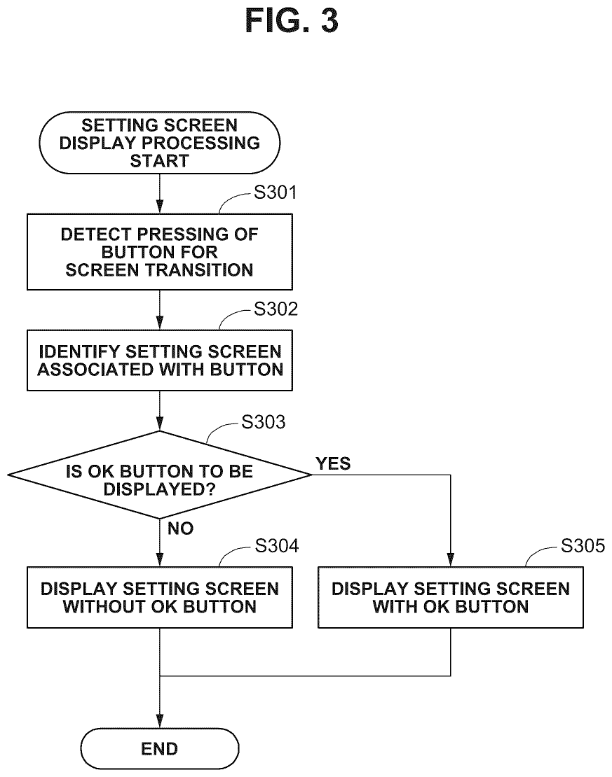

Hereinafter, processing for displaying a setting screen will be described with reference to FIGS. 3, 4A to 4C, and 5, but first, an example of an issue addressed in the present exemplary embodiment will be described.

In order to improve the usability of user interface (UI) screens, it is demanded to reduce the number of operations that a user is required to perform.

For example, on a setting screen for setting the setting content of a predetermined process, an object (or an area, or a software key) for setting (determining, registering, or reflecting) a setting value selected by the user from among a plurality of setting values as a setting value for the predetermined process is hidden. The object is referred to as a “determination button”. Then, based on an operation of selecting one setting value from among the plurality of options of the setting values (hereinafter, referred to as “one button operation”), the selected setting value is set (determined) to a predetermined item of the predetermined process.

This may reduce the number of operations that the user is required to perform. However, if the determination button is not displayed on the setting screen, the usability may be degraded depending on the type of the setting screen.

For example, in a case where there is a plurality of predetermined items to be set for a predetermined process, it is required to set a setting value for each of the plurality of items. In a setting screen for such processing, if the setting screen is configured to be closed when a one button operation is performed on any item, the setting screen is closed before a setting value is selected for an item different from the item on which the one button operation is performed, and thus the usability may be reduced. Therefore, in the setting screen that requires setting of a plurality of items, displaying the determination button allows the user to set setting values for the plurality of items by pressing the determination button after selecting a setting value for each of the plurality of items, and thus the convenience of the user can be enhanced.

However, even in a configuration in which the determination button is displayed on the setting screen that requires setting of setting values for a plurality of items, it is conceivable that the user performs an operation of closing the setting screen without noticing the determination button. For example, in a screen in which setting values can be set for a predetermined process by a one button operation, the determination button is not displayed as described above. Therefore, even though the determination button is displayed on the setting screen that requires setting of setting values for a plurality of items, the user may recognize that the setting screen is the same as the screen on which setting values can be set for a predetermined process by a one button operation and may perform an operation of closing the setting screen without pressing the determination button. In this case, a setting value selected by the user is not set to a predetermined item, which may result in an operation result unintended by the user.

The present exemplary embodiment aims to solve the above-described issue, for example. In the present exemplary embodiment, in a case where an operation of closing a setting screen is performed on the setting screen in which setting of setting values for a plurality of items is required, a notification screen regarding whether to set a setting value for a predetermined process is displayed. This can reduce the possibility of an operation result unintended by the user, for example, a case in which a setting value selected by the user is not set for a predetermined process, even if the user performs an operation of closing the setting screen without noticing the determination button.

In the present exemplary embodiment, the setting screen on which the determination button is displayed is not limited to a setting screen that requires setting of a plurality of items. For example, a configuration may be adopted in which the determination button is displayed on a specific setting screen.

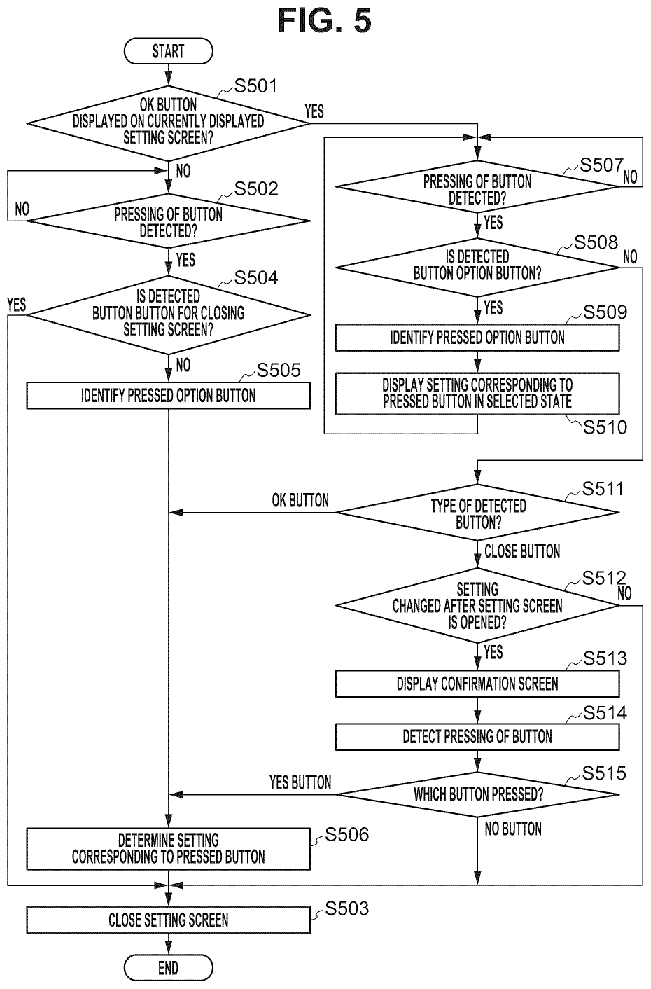

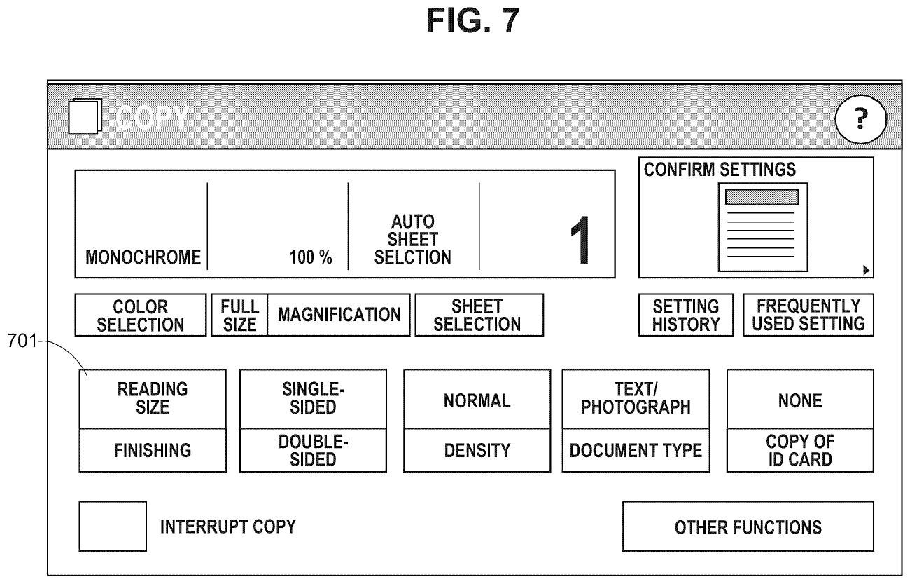

FIG. 3 is a flowchart illustrating an example of a process of displaying a setting screen. Each step of the flowcharts illustrated in FIGS. 3 and 5 (FIG. 5 will be described below) is processed by the CPU 100 of the image processing apparatus 1 executing a program. The program to be executed is called from the ROM 104 and causes each of the functional units illustrated in FIG. 2 to function. The processing in this flowchart is started based on pressing of a button for transitioning to a predetermined setting screen (for example, a button 701 in FIG. 7, which will be described below) (step S301).

In step S301, the button press receiving unit 203 detects pressing of a button related to a predetermined function on the display unit 120 of the image processing apparatus 1. FIG. 7 is a diagram illustrating an example of a screen of an application for setting a copy function that is a function for performing a predetermined process of the image processing apparatus 1. For example, the button press receiving unit 203 detects that the user has pressed the button 701 for transitioning to a setting screen relating to a reading size of a document, which is a predetermined setting item. When the user presses the button 701, the user can set a setting value related to the reading size of the document in the copy function on a predetermined setting screen to be displayed based on the pressing of the button 701. The predetermined setting screen of the image processing apparatus 1 may be any screen. For example, the predetermined setting screen may be a setting screen for setting the type of a document. The function of the image processing apparatus 1 for performing the predetermined process may be a predetermined function other than the copy function. Based on an operation performed on a region for opening a setting screen related to a predetermined item of the predetermined function, the setting screen for setting the setting content for the predetermined item is displayed.

Next, in step S302, the pressed button identification unit 204 identifies a setting screen associated with the button pressed in step S301.

Next, in step S303, the determination button display control unit 205 determines whether to display the determination button on the setting screen specified in step S302, based on the state of the image processing apparatus 1 and the operation status. The determination button is, for example, an “OK button”. This will be described in detail below.

For example, in an M-out-of-N selection setting screen in which M items are selected from N options (that is, a setting screen in which setting values for a plurality of setting items are required to be set), in a case where no OK button is displayed, the item selected first is determined by a one button operation and the screen is closed. As a result, the user cannot set the remaining setting items. Thus, in a case where the setting screen specified in step S302 is the M-out-of-N selection setting screen, the determination button display control unit 205 determines that “the OK button is to be displayed” in step S303 (YES in step S303).

On the other hand, for example, in a one-out-of-N selection setting screen in which one item is selected from N options (that is, a setting screen in which a setting value for one item is required to be set), it is possible to reduce the time and effort in the operation by determining the selection by a one button operation. Thus, in a case where the setting screen specified in step S302 is the one-out-of-N selection setting screen, the determination button display control unit 205 determines that “the OK button is not to be displayed” in step S303 (NO in step S303).

In step S303, whether the setting screen is the M-out-of-N selection setting screen or the one-out-of-N selection setting screen is determined for each screen specified in step S302. Alternatively, the determination may be made based on the types or the number of UI elements, such as a list included in the screen. For example, in a case where the user performs an operation of selecting a setting item from a displayed list of setting items, check boxes are typically displayed in the list in the case of the M-out-of-N selection setting screen. Thus, in this case, if the list with the check boxes is included in the screen, it may be determined that the setting screen is the M-out-of-N selection setting screen.

Based on a result of the determination in step S303, the setting screen display unit 201 switches display and non-display of the OK button depending on the situation. Specifically, if it is determined that the OK button is not to be displayed in the specified setting screen (NO in step S303), then in step S304, the setting screen display unit 201 displays the setting screen specified in step S302 as a setting screen in which the OK button is not displayed (i.e., the setting screen display unit 201 displays a setting screen that does not include the OK button and corresponds to the setting screen specified in step S302).

On the other hand, if it is determined that the OK button is to be displayed in in the specified setting screen (YES in step S303), then in step S305, the setting screen display unit 201 displays the setting screen specified in step S302 as a setting screen with the OK button (i.e., the setting screen display unit 201 displays a setting screen that includes the OK button and corresponds to the setting screen specified in step S302).

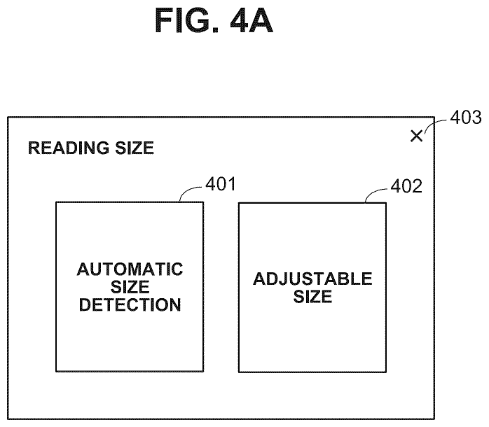

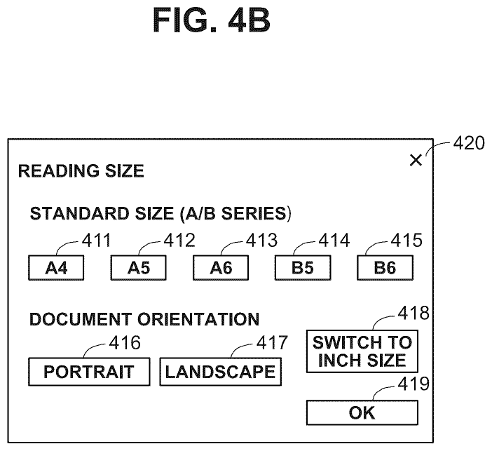

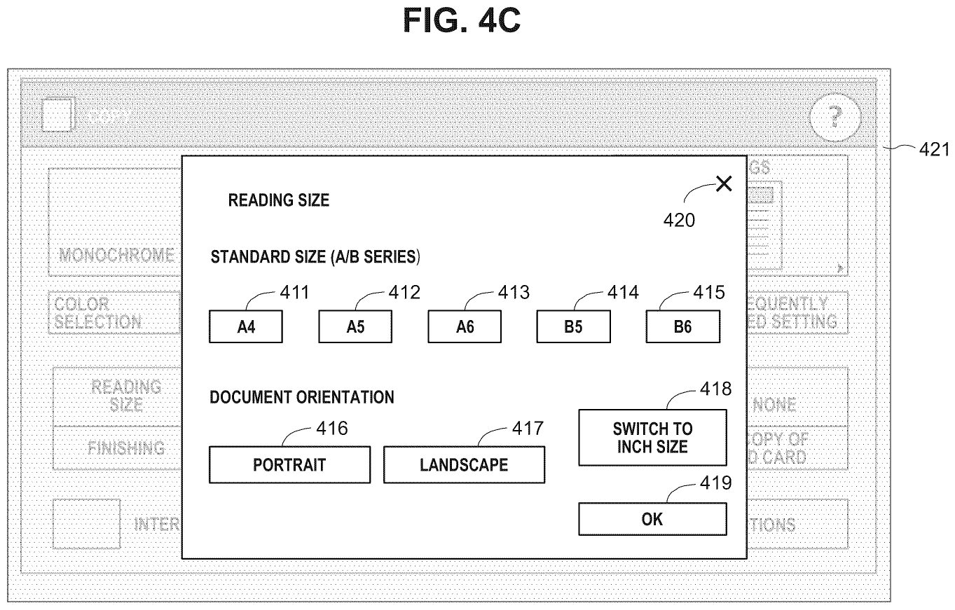

Examples of the setting screen are illustrated in FIGS. 4A and 4B.

FIG. 4A is a diagram illustrating an example of a setting screen for a reading size of a document.

The setting screen illustrated in FIG. 4A corresponds to an example of a setting screen in which an automatic size detection setting button 401, an adjustable size setting button 402, and a close button (“x” button) 403 for closing the setting screen are displayed, and the OK button (button for determining the selection) is not displayed. The setting screen illustrated in FIG. 4A corresponds to an example of a setting screen in which the number of setting items is one (only setting of the document size) and the close button is displayed. In the setting screen illustrated in FIG. 4A, there are two options of setting values for one item that is the reading size of the document. The selection determination unit 206 performs setting determination processing using one option selected out of the two options. That is, the selection determination unit 206 determines the setting by a one button operation.

FIG. 4B is a diagram illustrating an example of a setting screen for a reading size of a document for which setting values for a plurality of items are required to be set.

The setting screen illustrated in FIG. 4B corresponds to an example of a setting screen on which standard size setting buttons 411 to 415, document orientation setting buttons 416 and 417, a switch button 418 for switching to inch size setting, an OK button 419 indicating a determination button for determining the setting, and a close button 420 for closing the setting screen are displayed. That is, the setting screen illustrated in FIG. 4B corresponds to an example of a setting screen in which there is a plurality of setting items (here, setting of the document size and setting of the document orientation), and the OK button and the close button are displayed. Since one setting value can be selected for a predetermined setting item, one of the standard size setting buttons 411 to 415 can be selected as the setting value of the standard size, and one of the document orientation setting buttons 416 and 417 can be selected as the setting value of the document orientation. The switch button 418 for switching to inch size setting is a button for transitioning to a setting screen that allows the user to set the size of the document in inches. Similarly, in the screen after the transition, any of displayed inch sizes can be selected as a setting value.

Hereinafter, a process of determining selection on the setting screen will be described with reference to FIGS. 4A, 4B and 5.

FIG. 5 is a flowchart illustrating an example of a process of determining selection on the setting screen according to the first exemplary embodiment. The processing in the flowchart is started if the setting screen is displayed in step S304 or S305 in FIG. 3. It is assumed that, when the setting screen display unit 201 performs processing for closing the setting screen in step S503 of the processing in this flowchart and the processing in this flowchart is ended, the previous screen displayed before the setting screen is displayed will be displayed. However, the configuration is not limited to the foregoing configuration in which the previous screen displayed before the setting screen is displayed, and, for example, processing for displaying a dialog notifying that the setting has been determined may be performed.

In step S501, the setting screen display unit 201 determines whether the OK button is displayed on the setting screen currently displayed. If the OK button is not displayed (NO in step S501), the processing proceeds to step S502, and if the OK button is displayed (YES in step S501), the processing proceeds to S507 (described below). For example, if the screen illustrated in FIG. 4A is displayed, it is determined that the OK button is not displayed in step S501, and if the screen illustrated in FIG. 4B is displayed, it is determined that the OK button is displayed in step S501. If the OK button is not displayed on the setting screen (NO in step S501), the functional units illustrated in FIG. 2 perform control in step S502 and subsequent steps.

In step S502, the button press receiving unit 203 determines whether pressing of a button is detected. If it is determined that pressing of a button is detected (YES in step S502), the processing proceeds to step S504, and if it is determined that pressing of a button press is not detected, the processing of S502 is repeated.

In step S503, the setting screen display unit 201 closes the currently opened (displayed) setting screen, and the processing in the present flowchart is ended.

In step S504, the button press receiving unit 203 determines whether pressing of a button for closing the setting screen is detected. If it is determined that pressing of the button for closing the setting screen is detected in step S504 (YES in step S504), the processing proceeds to step S503. If it is determined that pressing of the button for closing the setting screen is not detected in step S504 (NO in step S504), the processing proceeds to step S505.

In a case where it is determined that pressing of the button for closing the setting screen is not detected in step S504, it is determined that pressing of an option button indicating a setting value is detected on the setting screen. For example, it is determined that pressing of any of the automatic size detection setting button 401 and the adjustable size setting button 402 illustrated in FIG. 4A is detected.

In step S505, the pressed button identification unit 204 identifies the option button indicating a setting value that is detected to be pressed in step S504. For example, the pressed button identification unit 204 identifies either one of the automatic size detection setting button 401 or the adjustable size setting button 402 illustrated in FIG. 4A.

In step S506, the selection determination unit 206 sets (registers or determines) a setting value corresponding to the button identified in step S505 as a setting value for a predetermined item of a predetermined process. For example, in the setting screen of FIG. 4A, either the automatic size detection setting button 401 or the adjustable size setting button 402, whichever is identified in step S505, is determined as the setting value for the reading size of the document.

If the setting is determined, then in step S503, the setting screen display unit 201 closes the setting screen, and the processing in the present flowchart is ended.

On the other hand, if the OK button is displayed on the setting screen (YES in step S501), the functional units illustrated FIG. 2 perform control in step S507 and subsequent steps.

In step S507 after it is determined that the OK button is displayed on the setting screen in step S501, the button press receiving unit 203 determines whether pressing of a button is detected. If it is determined that pressing of a button is detected, the processing proceeds to step S508, and if it is determined that pressing of a button press is not detected, the processing of step S507 is repeated.

In step S508, the pressed button identification unit 204 determines whether the pressed button is an option button indicating a predetermined setting value.

If it is determined that the pressed button is an option button indicating a predetermined setting value (YES in step S508), the processing proceeds to step S509, and if it is determined that the pressed button is not an option button indicating a predetermined setting value (NO in step S508), the processing proceeds to step S511. For example, the option button indicating a predetermined setting value is any of the standard size setting buttons 411 to 415 and any of the document orientation setting buttons 416 and 417 illustrated in FIG. 4B.

In step S509, the pressed button identification unit 204 identifies the pressed option button indicating a predetermined setting value. For example, the option button indicating a predetermined setting value is any one of the standard size setting buttons 411 to 415 and any one of the document orientation setting buttons 416 and 417 illustrated in FIG. 4B.

In step S510, the selection information storage unit 207 stores the setting value corresponding to the button identified in step S509 as a setting value being selected. The setting screen display unit 201 displays the button identified in step S509 in a display form where the button is in a selected state, and the processing returns to step S507. In step S507, the button press receiving unit 203 monitors whether a button is pressed.

On the other hand, in step S511 after it is determined that the pressed button is not an option button indicating a predetermined setting value in step S508, the pressed button identification unit 204 identifies the type of the pressed button that has been detected.

If the pressed button identification unit 204 determines that the detected pressed button is the OK button in step S511 (OK BUTTON in step S511), the processing proceeds to step S506, and the selection determination unit 206 sets the setting value stored as the selected setting value in the selection information storage unit 207 as the setting value for the predetermined item. For example, in the setting screen illustrated in FIG. 4B, when the OK button 419 for determining the setting is pressed, the setting value corresponding to any of the standard size setting buttons 411 to 415 and the setting value corresponding to any of the document orientation setting buttons 416 and 417 are set as the setting value of the standard size and the setting value of the document orientation, respectively. Then, in step S503, the setting screen display unit 201 closes the setting screen, and the processing in the present flowchart is ended.

On the other hand, in a case where the pressed button identification unit 204 determines that the pressed button is the button for closing the setting screen in step S511 (CLOSE BUTTON in step S511), the processing proceeds to step S512.

In step S512, the selection information storage unit 207 determines whether the selection of the setting value has been changed after the setting screen is opened. This determination is made based on whether the currently selected option stored in association with the setting screen in the selection information storage unit 207 has been changed. The currently selected option corresponds to the setting value set when the setting screen is opened last time. In other words, the selection information storage unit 207 determines whether the setting value selected as the setting value for the predetermined process has been changed from the setting value set for the predetermined process (i.e., whether the setting value selected as the setting value for the predetermined process is different from the setting value set for the predetermined process). More Specifically, in a case where at least one setting value for a predetermined item among the setting values related to the predetermined process has been changed from the setting value already set for the predetermined item, the selection information storage unit 207 determines that the selection of the setting value has been changed after the setting screen is opened in step S512. For example, in the setting screen illustrated in FIG. 4B, if the setting value of at least one item, among the setting values for the standard size setting and the document orientation setting, has been changed, the selection information storage unit 207 determines that the selection of the setting value has been changed after the setting screen is opened in step S512.

In a case where it is determined that the selection has not been changed after the setting screen is opened (NO in step S512), the processing proceeds to step S503. In step S503, the setting screen display unit 201 closes the setting screen, and the process in the present flowchart is ended.

On the other hand, if it is determined that the setting has been changed after the setting screen is opened (YES in step S512), the processing proceeds to step S513. In step S513, the confirmation screen display unit 202 displays a confirmation screen for confirming whether to reflect the selected setting value as the setting value for the predetermined process.

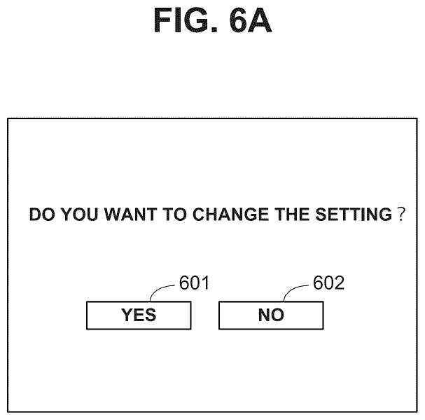

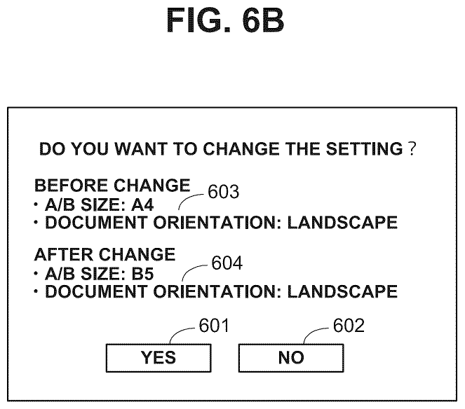

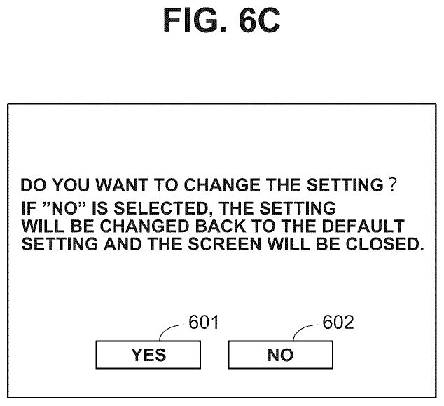

FIG. 6A is a diagram illustrating an example of the confirmation screen for confirming whether to reflect the selected setting value as the setting value for the predetermined process. In the example illustrated in FIG. 6A, a “Yes” button 601 for setting a setting value and a “No” button 602 for not setting a setting value are displayed on the confirmation screen.

In step S514, the button press receiving unit 203 detects pressing of a button on the confirmation screen. At this time, the pressed button identification unit 204 identifies the pressed button that has been detected. The button press receiving unit 203 may repeat the process of determining whether pressing of a button has been received until pressing of a button is received.

In step S515, the selection determination unit 206 determines whether the detected pressed button is the “Yes” button 601 for setting the selected setting value or the “No” button 602 for not setting the selected setting value.

If it is determined that the pressed button is the “No” button 602 (NO BUTTON in step S515), it is determined that the selection of the setting value on the setting screen is to be cancelled, and the processing proceeds to step S503. In step S503, the setting screen display unit 201 closes the setting screen, and the processing in the present flowchart is ended.

On the other hand, if it is determined that the pressed button is the “Yes” button 601 “(YES BUTTON in step S515), the processing proceeds to step S506. In step S506, the selection determination unit 206 sets the setting value corresponding to the button identified in step S514 as the setting value for the predetermined process. Then, the processing proceeds to step S503, and the setting screen display unit 201 closes the setting screen, and the processing in the present flowchart is ended.

In the above-described exemplary embodiment, on the setting screen displayed in a case where it is determined that the predetermined software key (OK button) for determining the selection is not required, the OK button is not displayed, and the setting is determined by the one button operation. This can reduce the number of operations and improve the usability. Further, on the setting screen (setting screen in which setting values for a plurality of items are required to be set) displayed in a case where it is determined that the OK button for determining the setting is required, the OK button is displayed and the selection is determined by pressing the OK button, whereby it is possible to reduce degradation in the usability. For example, it is possible to prevent a case in which the setting screen is closed before a setting value is selected for an item different from the item for which the one button operation is performed. Further, on the setting screen displayed in a case where it is determined that the OK button for determining the setting is required, if the button for closing the setting screen is pressed, the confirmation screen for confirming whether to set the changed setting value as the setting value for the predetermined item is displayed. This can reduce the possibility of an operation result unintended by the user, for example, a case in which a setting value selected by the user is not set for a predetermined item, even in a case where the user performs the operation of closing the setting screen without noticing the determination button.

The confirmation screen displayed in step S513 of the flowchart illustrated in FIG. 5 in the above-described exemplary embodiment may be a screen different from that illustrated in FIG. 6A.

For example, in step S513, the confirmation screen display unit 202 may display the content set by the user on the confirmation screen for confirming whether to reflect the selection of the setting value as the setting value for the predetermined item. Specifically, FIG. 6B is a diagram illustrating an example of the confirmation screen for confirming whether the selection is to be reflected. In the example illustrated in FIG. 6B, the “Yes” button 601 for setting the setting value, the “No” button 602 for not setting the setting value, a pre-change setting value display area 603, and a post-change setting value display area 604 are displayed on the confirmation screen. The confirmation screen display unit 202 acquires information before selection (the setting value set for the predetermined process) and information after selection (the setting value selected for the predetermined process on the setting screen) from the selection information storage unit 207. Thereafter, the confirmation screen display unit 202 displays the information before the selection in the pre-change setting value display area 603, and displays the information after the selection in the post-change setting value display area 604. FIG. 6B illustrates an example of the confirmation screen in a case where the setting has been changed in the screen in FIG. 4B which illustrates an example of the setting screen in which selection of a plurality of setting values is required for the reading size of the document. FIG. 6B indicates that the selected state has been changed from the state in which the standard size setting button (A4) 411 and the document orientation setting button (landscape) 417 are selected to the state in which the standard size setting button (B5) 414 and the document orientation setting button (landscape) 417 are selected. This allows the user to specifically confirm the selection to be reflected on the confirmation screen for confirming whether to reflect the selection, and therefore the usability is improved.

For example, in step S513, the confirmation screen display unit 202 may reflect a default setting value (initial value) on the confirmation screen for confirming whether the selection of the setting value is reflected as the setting value for the predetermined item, in a case where the setting value is not to be reflected. In a case where the selection determination process is performed again after the selection is determined in the flow of processing in FIG. 5, it is confirmed in step S513 whether the initial value stored in the selection information storage unit 207 is to be changed. For example, a confirmation screen illustrated in FIG. 6C is displayed with the message “Do you want to change the settings? If ‘No’ is selected, the setting will be changed back to the default setting and the screen will be closed”. If “NO” (“No” button 602) is selected in the screen illustrated in FIG. 6C (“NO BUTTON” in step S515), the initial value stored in the selection information storage unit 207 is determined, and then the setting screen is closed in step S503.

Further, in the above-described exemplary embodiment, the button for closing the setting screen displayed on the setting screen may be a UI element other than a button such as the close button 420 for closing the setting screen. For example, a screen illustrated in FIG. 4C can be considered in which an example of the setting screen for the reading size of the document illustrated in FIG. 4B is displayed as a pop-up to be superimposed on another screen. If the user presses an area 421 outside the pop-up in the screen illustrated in FIG. 4C, the button press receiving unit 203 may determine that the close button 420 for closing the setting screen is pressed and close the setting screen.

Furthermore, the image processing apparatus 1 according to the above-described exemplary embodiment may have a mode in which the processes in steps S512 and S513 of the flowchart in FIG. 5 are executed (a mode in which the confirmation screen for confirming whether to reflect the selection of the setting value is displayed) and a mode in which the processes in steps of S512 and 513 are not executed (a mode in which the confirmation screen for confirming whether to reflect the selection of the setting is not displayed), and any one of the modes may be selectable. Specifically, in the mode in which the confirmation screen for confirming whether to reflect the selection of the setting value is displayed, the flowchart in FIG. 5 is executed as in the above-described exemplary embodiment. In the mode in which the confirmation screen for confirming whether to reflect the selection of the setting value is not displayed, if the type of the button detected in step S511 is the “close button”, the processing proceeds to step S503, and the setting screen display unit 201 executes the processing for closing the setting screen. That is, when the “close button” is pressed on the setting screen, the setting screen display unit 201 does not display the confirmation screen for confirming whether to reflect the setting and closes the setting screen without setting the setting value even in a case where the setting value has been changed.

The structures and content of the various data described above are not limited to those described above, and the various data may be configured with various structures and content depending on the application and purpose.

Embodiments of the present disclosure can be implemented as, for example, a system, an apparatus, a method, a program, or a storage medium. More specifically, embodiments of the present disclosure may be applied to a system constituted by a plurality of devices, or may be applied to an apparatus constituted by a single device.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-129008, filed Aug. 8, 2023, which is hereby incorporated by reference herein in its entirety.

What is claimed is:

1. An image processing apparatus comprising:
a display control unit configured to display a setting screen for receiving setting of a setting value for a predetermined process; and
a receiving unit configured to receive a user operation on a predetermined region indicating closing of the setting screen on the setting screen,
wherein the display control unit displays a notification screen regarding whether to set the setting value received in the setting screen for the predetermined process in a case where a user operation on the predetermined region is received, executes first control to set the setting value for the predetermined process in a case where an operation indicating that the setting value is to be set for the predetermined process is received in the notification screen, and executes second control to not set the setting value for the predetermined process in a case where an operation indicating that the setting value is not to be set for the predetermined process is received in the notification screen.

2. The image processing apparatus according to claim 1, wherein the display control unit executes the first control and closes the setting screen in a case where the operation indicating that the setting value is to be set for the predetermined process is received in the notification screen, and executes the second control and closes the setting screen in a case where the operation indicating that the setting value is not to be set for the predetermined item is received in the notification screen.

3. The image processing apparatus according to claim 1, wherein the predetermined region is a predetermined software key for closing the setting screen.

4. The image processing apparatus according to claim 1, wherein the setting screen is a setting screen in which a specific region for setting the setting value for the predetermined process is displayed, the specific region being different from a region indicating the setting value.

5. The image processing apparatus according to claim 4, further comprising a determination unit configured to determine whether the setting screen includes the specific region,
wherein the display control unit displays the notification screen and executes the first control and the second control in a case where the determination unit determines that the setting screen includes the specific region and a user operation on the predetermined region is received.

6. The image processing apparatus according to claim 5, wherein, in a case where the determination unit determines that the setting screen does not include the specific region and the region indicating the setting value is operated, the display control unit sets a setting value corresponding to the operated region indicating the setting value for the predetermined process and performs control to close the setting screen.

7. The image processing apparatus according to claim 6, wherein the specific region is a specific software key for setting the setting value for the predetermined process.

8. The image processing apparatus according to claim 4, wherein the setting screen that does not include the specific region is a screen in which a number of setting items related to the predetermined process is one.

9. The image processing apparatus according to claim 1, wherein, in a case where a user operation on the predetermined region is received, the display control unit displays the notification screen and executes the first control and the second control based on a change of at least one of setting values selected as a setting value for the predetermined process from the setting value set for the predetermined process.

10. The image processing apparatus according to claim 1, further comprising a determination unit configured to determine whether at least one of setting values selected as a setting value for the predetermined process is changed from the setting value set for the predetermined process,
wherein, in a case where a user operation on the predetermined region is received and the determination unit determines that at least one of the setting values selected as the setting value for the predetermined process is changed from the setting value set for the predetermined process, the display control unit displays the notification screen and executes the first control and the second control.

11. The image processing apparatus according to claim 1, wherein the setting screen is a screen in which a plurality of setting items related to the predetermined process is included.

12. The image processing apparatus according to claim 11, wherein, in a case where the operation indicating that the setting value is to be set for the predetermined process is received in the notification screen, a setting value corresponding to one region selected from a plurality of regions indicating setting values for the plurality of setting items is set as the setting value for the predetermined process.

13. The image processing apparatus according to claim 12, wherein the one region selected from the plurality of regions indicating the setting values for the plurality of setting items on the setting screen is displayed in a state indicating that the one region is selected.

14. The image processing apparatus according to claim 1, wherein the display control unit further displays, on the notification screen, a setting value set for the predetermined process and the setting value selected for the predetermined process on the setting screen.

15. The image processing apparatus according to claim 1,
wherein, in a case where the operation indicating that the setting value is not to be set for the predetermined process is received in the notification screen, the display control unit sets an initial setting value for the predetermined process and closes the setting screen.

16. The image processing apparatus according to claim 1, wherein the display control unit further displays, on the notification screen, information indicating that, in a case where the operation indicating that the setting value is not set for the predetermined process is received, an initial setting value is set for the predetermined process and the setting screen is closed.

17. The image processing apparatus according to claim 1, wherein, when the image processing apparatus is in a mode in which the notification screen is not displayed, the display control unit does not execute the first control and the second control even in a case where a user operation on the predetermined region is received.

18. A control method for an image processing apparatus, the control method comprising:
displaying a setting screen for receiving setting of a setting value for a predetermined process;
receiving a user operation on a predetermined region indicating closing of the setting screen on the setting screen,
wherein a notification screen regarding whether to set the setting value received in the setting screen for the predetermined process is displayed in a case where a user operation on the predetermined region is received, first control for setting the setting value for the predetermined process is executed in a case where an operation indicating that the setting value is to be set for the predetermined process is received in the notification screen, and second control for not setting the setting value for the predetermined process is executed in a case where an operation indicating that the setting value is not to be set for the predetermined process is received in the notification screen.

19. A non-transitory computer-readable storage medium storing a program causing a computer of an image processing apparatus to execute:
displaying a setting screen for receiving setting of a setting value for a predetermined process;
receiving a user operation on a predetermined region indicating closing of the setting screen on the setting screen,
wherein a notification screen regarding whether to set the setting value received in the setting screen for the predetermined process is displayed in a case where a user operation on the predetermined region is received, first control for setting the setting value for the predetermined process is executed in a case where an operation indicating that the setting value is to be set for the predetermined process is received in the notification screen, and second control for not setting the setting value for the predetermined process is executed in a case where an operation indicating that the setting value is not to be set for the predetermined process is received in the notification screen.
